(19) United States
(12) Patent Application Publication
(10) Pub. No.: US 2003/0000769 A1
(43) Pub. Date: Jan. 2, 2003

(54) Powered hunting stand

(76) Inventor: Gary Lee Pyle, Chico, TX (US)

Correspondence Address: THOMPSON & KNIGHT L.L.P., PATENT PROSECUTION DEPARTMENT, 801 CHERRY ST., SUITE 1600, FORT WORTH, TX, 76102, US

(21) Appl. No.: 09/893,071

(22) Filed: Jun. 27, 2001

(51) Int. Cl. E06C 5/00

(52) U.S. Cl. 182/63.1; 182/127

(57) ABSTRACT

A hunting stand for elevating and supporting a hunter during a hunt is provided. The hunting stand features a collapsible and mobile lifting apparatus for raising a platform supporting persons and equipment to a desired height. In particular, the hunting stand can be easily transported by either towing the stand behind a vehicle or by mounting the stand on the roof of a vehicle. The lifting apparatus of the hunting stand is pneumatically or hydraulically powered. Because lifting cylinders are used to extend and collapse the collapsible frames, complex lifting mechanisms such as those requiring pulleys or gears are avoided. Further, the lifting apparatus is designed as a modular feature unit, so that it can be configured with more or fewer collapsible frames, depending on the desired height of the concealment enclosure. The hunting stand also allows the lifting apparatus to keep the concealment enclosure level as the concealment enclosure is raised and lowered.

### BACKGROUND OF THE INVENTION

1. Field of the Invention

This invention relates in general to hunting stands for hunting wildlife and in particular to a mobile hunting stand capable of providing a powered, elevated hunting platform that is easily raised or lowered.

2. Description of Related Art

Hunters throughout the world routinely hunt various forms of wildlife, including deer, elk, feral hogs, bear, waterfowl, and many other animal species. Although the methods and equipment associated with hunting often vary depending on the particular animal being hunted, one element that is almost always required for successful hunting is the element of concealment. If a hunter does not remain concealed from his prey, either through the use of camouflage clothing and natural surroundings, or through the use of man-made structures such as hunting blinds, the hunter's odds of success decrease dramatically.

Various types of hunting blinds and hunting stands have been developed to aid in the concealment of hunters. Blinds having tower structures that are capable of being towed behind a pickup track are generally known. Additionally, it is known to provide a vertically extendable and retractable platform on a trailer that is capable of being towed by a towing vehicle or an all terrain vehicle.

Despite the general availability of extendable and retractable hunting stands, these stands are often bulky and require enormous amounts of space for storing the frame components of the hunting stand when in a retracted position. Additionally, the mechanisms and frames built to provide extendability and retractability are often complicated and require excessive amounts of construction material, thereby making the hunting stand unduly expensive and heavy. Finally, it is often not feasible to transport an extendable and retractable blind on a trailer. Often the areas accessed by hunters is very remote and contains excessive brush and vegetation. In such areas, it is undesirable to tow a trailer behind a vehicle since the trailer will effectively limit the turning radius of the vehicle.

A need exists, therefore, for an extendable and collapsible hunting stand that occupies a small amount of space in a fully collapsed position. A need also exists for such a hunting stand having simple frame components and lifting mechanisms in order to decrease costs and weight. Finally, a need exists for an extendable and collapsible hunting stand that can be easily transported and operated from the roof of a sport utility vehicle.

### BRIEF SUMMARY OF THE INVENTION

The problems presented in providing mobile, elevated platforms for hunting deer and other wildlife are solved by the systems and methods of the present invention. A preferred embodiment of the invention provides a collapsible and mobile lifting apparatus for raising a platform supporting persons and equipment to a desired height. In particular, the preferred embodiment provides that the hunting stand can be easily transported by either towing the stand behind a vehicle or by mounting the stand on the roof of a vehicle. According to the disclosed embodiments, the lifting apparatus is pneumatically or hydraulically powered. Because lifting cylinders are used to extend and collapse the collapsible frames, complex lifting mechanisms such as those requiring pulleys or gears are avoided. Further, the lifting apparatus is designed as a modular feature unit, so that it can be configured with more or fewer collapsible frames, depending on the desired height of the concealment enclosure. The preferred embodiment also allows the lifting apparatus to keep the concealment enclosure level as the concealment enclosure is raised and lowered.

Other objects, features, and advantages of the present invention will become apparent with reference to the drawings and detailed description which follow.

### BRIEF DESCRIPTION OF THE DRAWINGS

FIG. 1 illustrates a perspective view of a hunting stand according to the present invention, the hunting stand being configured to be towed as a trailer behind a vehicle.

FIG. 2 depicts a side view of the hunting stand of FIG. 1 in a filly extended position.

FIG. 3 illustrates a side view of the hunting stand of FIG. 1 in an intermediate position.

FIG. 4 depicts a perspective view of the hunting stand of FIG. 1 in a fully collapsed position.

FIG. 5 illustrates an alternate embodiment of a hunting stand according to the present invention, the hunting stand being configured for transportation in an automobile carrier atop a sport utility vehicle.

FIG. 6 depicts a side view of the hunting stand of FIG. 1, the hunting stand having modular features which allow the attachment of additional collapsible frames, thereby increasing the fully extended height of the hunting stand.

### DETAILED DESCRIPTION OF THE PREFERRED EMBODIMENT

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

In accordance with one embodiment of the present invention, a lifting apparatus having a first collapsible frame and a second collapsible frame is provided. Each of the frames includes a plurality of struts, each strut having a first end and a second end. Each strut of the first collapsible frame has the first end pivotally attached to one of a plurality of lower longitudinal cross members and the second end pivotally attached to one of a plurality of upper longitudinal cross members. Each strut of the second collapsible frame has the first end pivotally attached to a base and the second end pivotally attached to one of the lower longitudinal cross members. A first lifting cylinder is pivotally attached at one end to one of the lower longitudinal cross members and pivotally attached at another end to one of the struts of the first collapsible frame. A second lifting cylinder is pivotally attached at one end to the base and pivotally attached at another end to one of the struts of the second collapsible frame.

A hunting stand having a lower collapsible frame and an upper collapsible frame is also provided. The lower collapsible frame includes at least one lifting strut and at least one support strut, one end of the lifting strut and one end of the support strut being pivotally attached to a base. Another end of the lifting strut and another end of the support strut are pivotally connected to a lower longitudinal cross member. An upper collapsible frame includes at least one lifting strut and at least one support strut, one end of the lifting strut and one end of the support strut being pivotally attached to the lower longitudinal cross member. Another end of the lifting strut and another end of the support strut for the upper collapsible frame are pivotally connected to an upper longitudinal cross member. The hunting stand also includes a first lifting cylinder that is pivotally attached to the lifting strut of the upper collapsible frame for rotating the frame between a collapsed and an extended position. A second lifting cylinder is pivotally attached to the lifting strut of the lower collapsible frame for rotating the frame between a collapsed and an extended position.

The present invention also provides a method for raising a concealment enclosure. The method includes the step of supporting the concealment enclosure with a first collapsible frame having a plurality of struts. The struts of the first collapsible frame are pivotally attached at a first end to one of a plurality of lower longitudinal cross members and are pivotally attached at a second end to one of a plurality of upper longitudinal cross members. The method also includes the step of supporting the first collapsible frame with a second collapsible frame having a plurality of struts. Each strut of the second collapsible frame is pivotally attached at a first end to a base and at a second end to one of the lower longitudinal cross members. Finally, the method includes the steps of rotating the first collapsible frame and rotating the second collapsible frame from a collapsed position to an extended position.

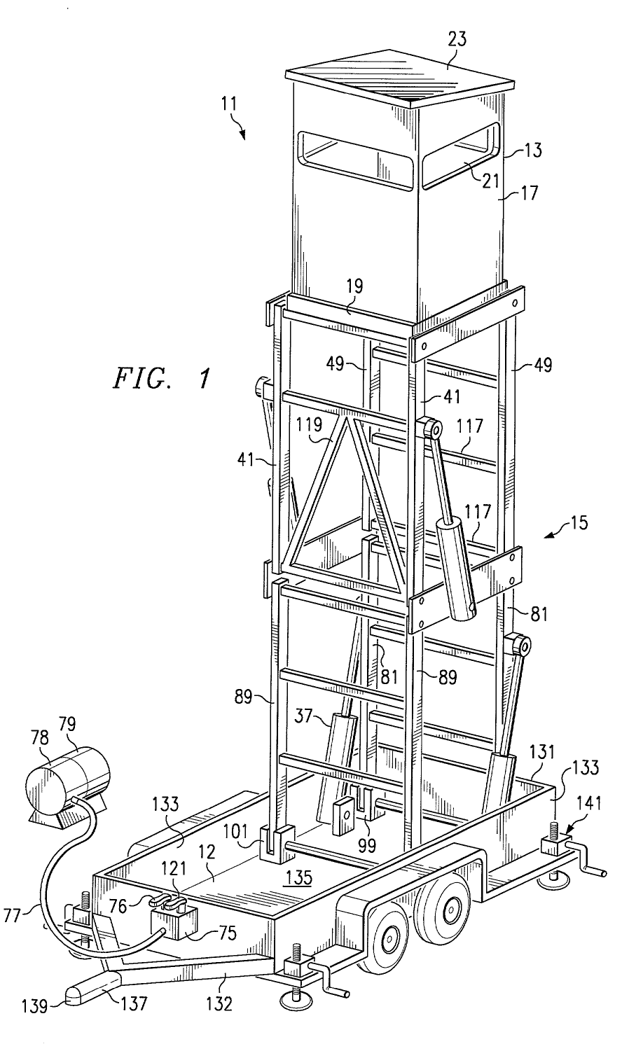

Referring to FIG. 1 in the drawings, a hunting stand 11 according to the present invention is illustrated. Hunting stand 11 includes a base 12, a concealment enclosure 13, and a lifting apparatus 15. Concealment enclosure 13 is typically used to house a person while hunting deer or other wildlife. Hunters often refer to such a concealment enclosure as a “hunting blind.” Typically, concealment enclosure 13 will have four walls 17 supported by a base 19, although more or fewer walls could be present. Window holes 21 are generally cut at selected locations in the walls 17 to allow the hunter to view and shoot at the animals that are being hunted. A door or access panel (not shown) is typically provided in one of the walls 17 to allow entry to and exit from concealment enclosure 13. A roof 23 is rigidly and securely fastened to walls 17 to protect the hunter from the elements and further aid in concealment.

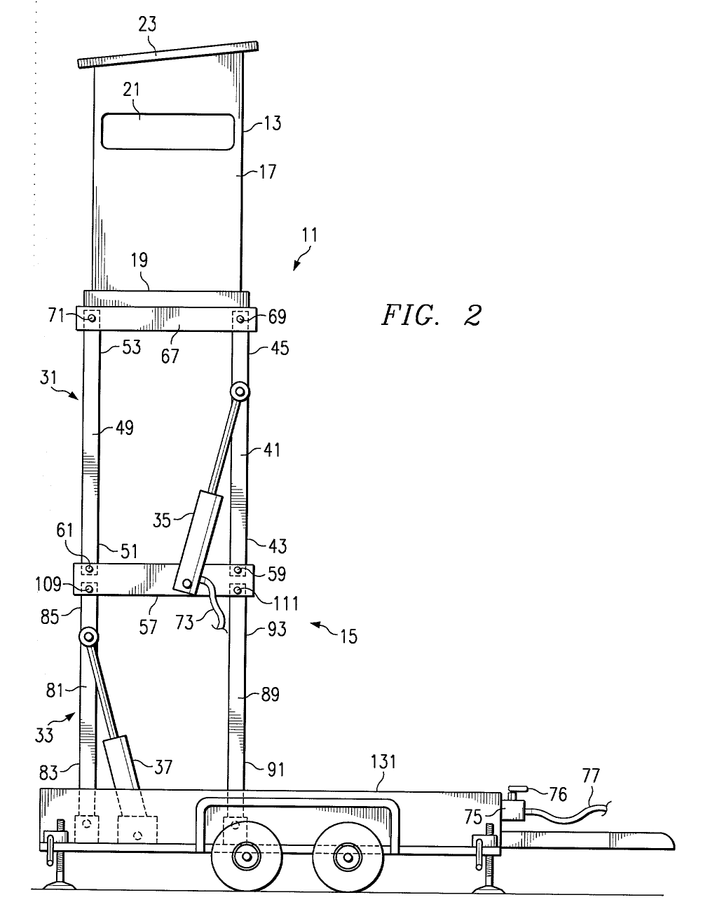

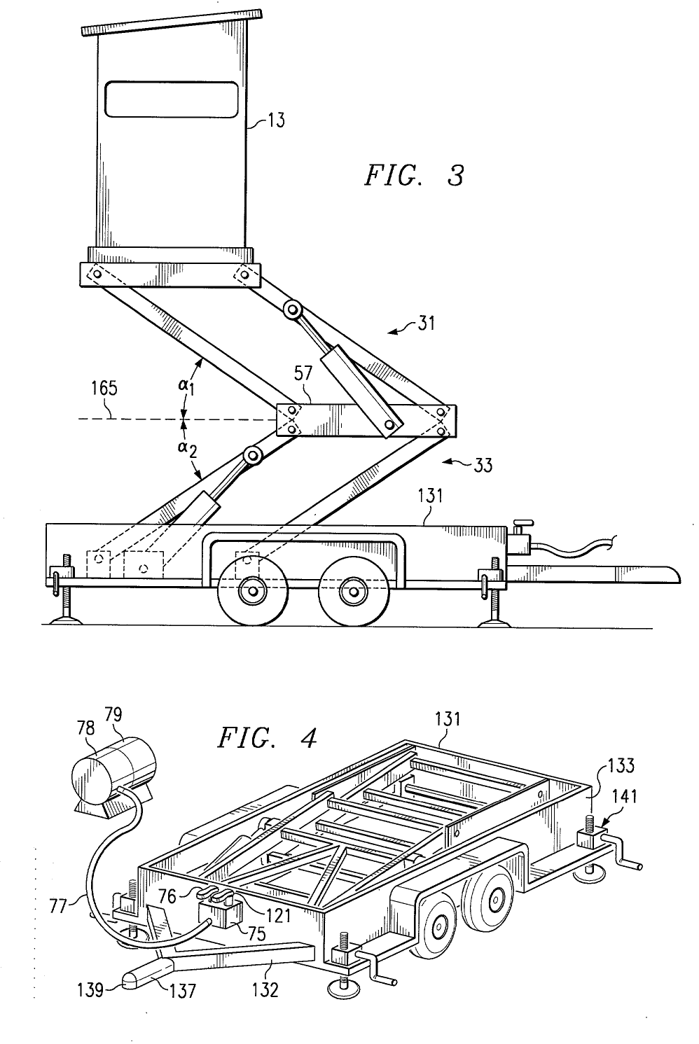

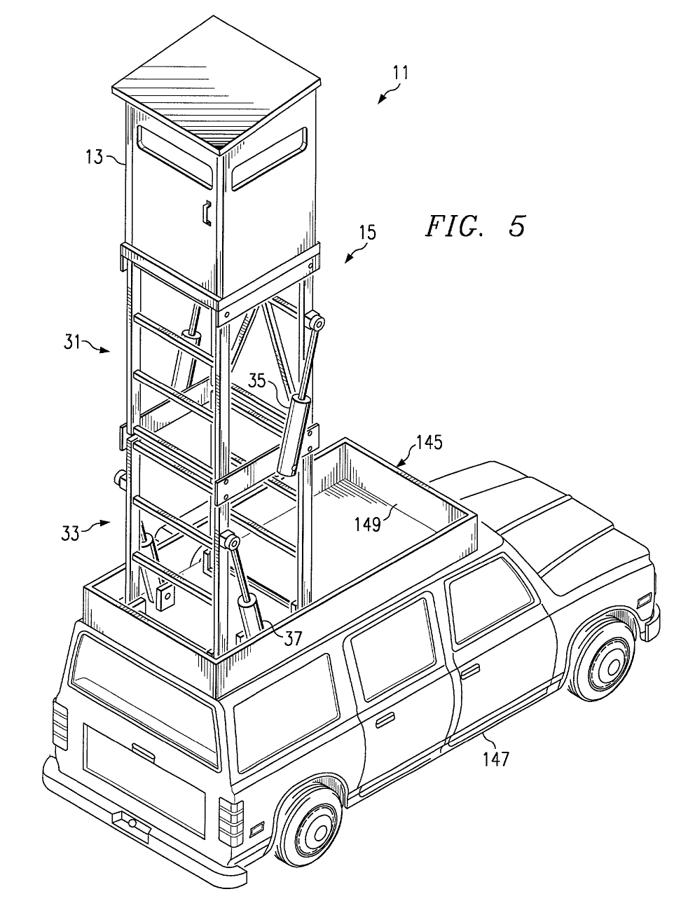

Referring still to FIG. 1, but also to FIGS. 2, 3 and 4 in the drawings, lifting apparatus 15 is provided to raise and lower concealment enclosure 13. Lifting apparatus 15 includes a first, or upper collapsible frame 31 and a second, or lower collapsible frame 33. A first lifting cylinder 35 is provided to move upper collapsible frame 31 between a collapsed position and an extended position. A second lifting cylinder 37 is provided to move lower collapsible frame 33 between a collapsed position and an extended position. Together, lifting cylinders 35, 37 provide the ability to move lifting apparatus 15 between a fully collapsed position (shown in FIG. 4), in which both collapsible frames 31, 33 are in the collapsed position, and a fully extended position (shown in FIG. 2), in which both collapsible frames are in the extended position. A plurality of intermediate positions, one of which is illustrated in FIG. 3, are attainable between the fully collapsed position and the fully extended position.

In a preferred embodiment, upper collapsible frame 31 includes a pair of lifting struts 41, each lifting strut having a first end 43 and a second end 45. Upper collapsible frame 31 also includes a pair of support struts 49, each support strut having a first end 51 and a second end 53. The first ends of the lifting struts 41 and the support struts 49 are pivotally attached to a pair of lower longitudinal cross members 57. Preferably, each lower longitudinal cross member 57 has one of the lifting struts 41 attached at a lower lifting point 59 and one of the support struts 49 attached at a lower support point 61.

The second ends of the lifting struts 41 and the support struts 49 are pivotally attached to a pair of upper longitudinal cross members 67 in a similar fashion. Each of the upper longitudinal cross members 67 has one of the lifting struts 41 attached at an upper lifting point 69 and one of the support struts 49 attached at an upper support point 71. For each pair of struts (one lifting strut 41 and one support strut 49) connected to the same upper longitudinal cross member 67, the distance between the upper lifting point 69 and the upper support point 71 is equal to the distance between the lower lifting point 59 and the lower support point 61. Additionally, all of the lifting struts 41 and support struts 49 of upper collapsible frame 31 are equal in length in that portion of the strut between the point of attachment to upper longitudinal cross member 67 and the point of attachment to lower longitudinal cross member 57.

First lifting cylinder 35 is pivotally attached at one end to lower longitudinal cross member 57 and at another end to lifting strut 41. Preferably, one first lifting cylinder 35 is attached to each lifting strut 41; however, it is possible that one first lifting cylinder 35 could be used to control the movement of upper collapsible frame 31. Further, each lifting cylinder 35 is preferably attached to lower longitudinal cross member 57 at a position that is out-of-line with and lower than lower lifting point 59 and lower support point 61. Each first lifting cylinder 35 is either hydraulically or pneumatically operated. A hose 73 is fluidly attached to each first lifting cylinder 35 for providing compressed air or compressed hydraulic fluid to the lifting cylinder, depending on the type of lifting cylinder being used. Each hose 73 is routed along the lower collapsible frame 33 and is fluidly connected to a manifold 75. Manifold 75 is fluidly associated with a valve 76, and is fluidly connected to one end of a supply hose 77. Preferably, supply hose 77 is fluidly connected at another end to a compressor 78. Compressor 78 is operably connected to a motor 79 and supplies compressed air to manifold 75. By operating valve 76, compressed air is selectively supplied to each of the first lifting cylinders 35 through each of the hoses 73. In one alternative configuration, an air tank (not shown) containing compressed air could replace the compressor 78 and motor 79. If first lifting cylinder 35 were hydraulically operated, the compressor would be replaced by a hydraulic pump (not shown). The hydraulic pump would pressurize hydraulic fluid, which would then be delivered through hoses 73 to operate the first lifting cylinders 35.

Lower collapsible frame 33 includes a pair of lifting struts 81, each lifting strut having a first end 83 and a second end 85. Lower collapsible frame 33 also includes a pair of support struts 89, each support strut having a first end 91 and a second end 93. The first ends of the lifting struts 81 and the support struts 89 are pivotally attached to base 12. Preferably, each of the lifting struts 81 is attached to base 12 at a base lifting point 99 and each of the support struts 89 is attached to base 12 at a base support point 101. It should be noted that, in each stage, both the upper and lower attachment points of the lifting struts and can be vertically offset from the upper and lower attachment points of the support struts so that the stage can fully collapse to a substantially flat position.

The second ends of the lifting struts 81 and the support struts 89 are pivotally attached to the pair of lower longitudinal cross members 57. Each of the lower longitudinal cross members 57 has one of the lifting struts 81 attached at a lower lifting point 109 and one of the support struts 89 attached at a lower support point 111. For each pair of struts (one lifting strut 81 and one support strut 89) connected to the same lower longitudinal cross member 57, the distance between lower lifting point 109 and lower support point 111 is equal to the distance between base lifting point 99 and base support point 101. Additionally, all of the lifting struts 81 and support struts 89 are equal in length in that portion of the strut between the point of attachment to lower longitudinal cross member 57 and the point of attachment to base 12.

Second lifting cylinder 37 is pivotally attached at one end to base 12 and at another end to lifting strut 81. Preferably, one second lifting cylinder 37 is attached to each lifting strut 81; however, it is possible that one second lifting cylinder 37 could be used to control the movement of lower collapsible frame 33. Each second lifting cylinder 37 is either hydraulically or pneumatically operated. A hose (not shown) is fluidly attached to each second lifting cylinder 37 for providing compressed air or compressed hydraulic fluid to the lifting cylinder, depending on the type of lifting cylinder being used. Each hose is routed along the base 12 and is fluidly connected to manifold 75. Manifold 75 is fluidly associated with a valve 121. As mentioned previously, supply hose 77 provides pressurized fluid to manifold 75. This fluid is selectively routed to each second lifting cylinder 37 by selectively operating valve 121.

It can be seen by one having skill in the art that valves 76, 121 could be manual valves or electrically controllable valves having an associated controller (not shown). If electrically controllable valves are used, a transmitter and receiver can be employed to remotely control operation of the valves, thereby allowing concealment enclosure 13 to be raised and lowered from within concealment enclosure 13.

A plurality of lateral cross members 117 and cross braces 119 are provided for both the upper collapsible frame 31 and the lower collapsible frame 33. Preferably, each pair of support struts 49, 89 are strengthened by rigidly attaching lateral cross members 117 between the support struts as demonstrated in FIG. 1. Each pair of lifting struts 41, 81 are strengthened by rigidly attaching lateral cross members 117 and cross braces 119 between the lifting struts. In a preferred embodiment, lateral cross members 117 and cross braces 119 are attached to the other frame members by welding. Depending on the particular design and size of lifting apparatus 15, the placement and number of lateral cross members 117 and cross braces 119 could vary. In one embodiment, lateral cross members 117 could be positioned to serve as steps for a hunter who desires to enter or exit concealment enclosure 13 when lifting apparatus 15 is in a fully extended position.

It should be noted that lateral cross members 117 are also rigidly attached between each pair of support struts 49, 89 at both ends of the support struts 49, 89. Similarly, lateral cross members 117 are rigidly attached between each pair of lifting struts 41, 81 at both ends of the lifting struts 41, 81. While it was previously mentioned in this description that each strut is pivotally attached to a longitudinal cross member 57, 67 or base 12, the pivotal attachment of each strut may be accomplished by pivotally attaching the lateral cross member 117 to the longitudinal cross member 57, 67 or base 12. Since the struts are rigidly attached to lateral cross members 117 at each end of the strut, the pivotal attachment of these lateral cross members 117 to longitudinal cross member 57, 67 or base 12 would effectively provide the same functionality as if the strut itself were pivotally attached to longitudinal cross member 57, 67 or base 12.

Concealment enclosure 13 is rigidly attached to upper longitudinal cross members 67. In one configuration, base 19 of concealment enclosure 13 would be rigidly attached to upper longitudinal cross member 67 using fasteners or by welding. In another configuration, base 19 of concealment enclosure 13 may be integral to upper longitudinal cross member 61 such that the second ends of struts 41, 49 are pivotally attached to the base 19 of concealment enclosure 13.

In the embodiment illustrated in FIG. 1, a trailer 131 is provided to transport, house, and support hunting stand 11. Trailer 131 includes a chassis 132, walls 133, and a floor 135. The number and material composition of walls 133 could vary. When lifting device 15 is in the fully collapsed position (see FIG. 4), walls 133 are of equal or greater height than the collapsed lifting device 15. The walls 133 act to protect and conceal the lifting device 15 when the lifting device 15 is in the fully collapsed position. Preferably, base 12, upon which lifting device 15 is mounted, is integral to floor 135. Trailer 131 also includes a trailer tongue 137 having a ball hitch 139 for towing behind an automobile or an all terrain vehicle (ATV). Retractable leveling jacks 141 are attached at each comer of the chassis 132 for stabilizing the trailer 131 during operation of lifting apparatus 15.

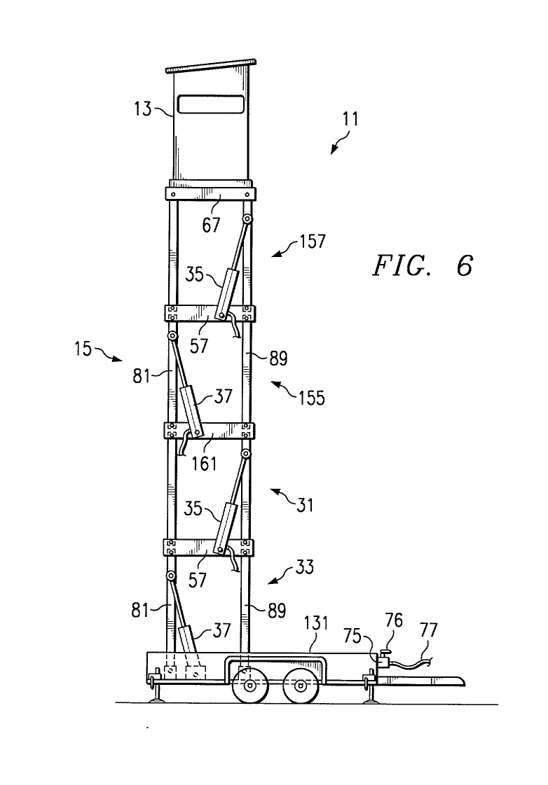

Referring now to FIG. 5 in the drawings, an alternative embodiment is illustrated in which an automobile carrier 145 is provided to transport, house, and support hunting stand 11. Automobile carrier 145 is rigidly mounted to a roof of a sport utility vehicle (SUV) 147 or in a bed of a pickup truck (not shown). Automobile carrier 145 includes walls 149 and a floor (not shown) similar to those on trailer 131. Walls 149 are as low profile as possible to prevent excessive drag during operation of SUV 147. Depending on the type of lifting cylinders used, the compressor 78, the air tank, or the hydraulic pump may be mounted to the body of SUV 147. If compressor 78 or the hydraulic pump is used, an engine that powers SUV 147 may also be used to provide power to compressor 78 or the hydraulic pump.

Referring to FIG. 6 in the drawings, a modular feature of the present invention is illustrated. In the event that it is desired to raise concealment enclosure 13 to a greater height, additional collapsible frames can be added to increase the fully extendable height of lifting apparatus 15. As can be seen in FIG. 6, an additional lower collapsible frame 155 and an additional upper collapsible frame 157 can be attached above the upper collapsible frame 31 shown in FIG. 2. The interconnections and operations of the lower and upper collapsible frames 155, 157 are similar to those for upper and lower collapsible frames 31, 33 illustrated in FIG. 2. One difference, however, is that the struts 81, 89 of lower collapsible frame 155 are no longer attached at their first ends to base 12. Instead the first ends of the struts are pivotally attached to a pair of longitudinal joining members 161 that are similar in structure to lower longitudinal cross members 57. Longitudinal joining member 161 replaces each upper longitudinal cross member 67 at the second ends of the struts of upper collapsible frame 31. Upper longitudinal cross member 67 is instead pivotally connected to the second ends of the struts of upper collapsible frame 157 (similar to the connection in FIG. 2).

In operation, hunting stand 11 is transported to an area in which a hunter desires to hunt or observe animals or terrain. If hunting stand 11 is configured in a trailer configuration, as in FIGS. 1-4, and 6, the hunting stand 11 is transported by towing the trailer 131 behind an automobile or ATV. Preferably, hunting stand 11 is transported in a fully collapsed position. Upon arrival at a selected location, hunting stand 11 can be used either with the trailer 131 attached to the vehicle or unattached. In either case, trailer 131 is secured by extending leveling jacks 141. Leveling jacks 141 essentially widen the “footprint” of trailer 131, thereby adding stability as lifting apparatus 15 is raised.

If hunting stand 11 is configured in an automobile carrier configuration, as illustrated in FIG. 5, hunting stand 11 is transported on top of SUV 147 or in the bed of a pickup without the need for a trailer. Hunting stand 11 can be operated from the roof of SUV 147, or the automobile carrier 145 can be removed from the roof and placed on a flat surface such as the ground. If removed from the vehicle, leveling jacks (not shown) similar to those used with trailer 131 would be employed to stabilize hunting stand 11 during use.

A hunter wishing to hunt from concealment enclosure 13 raises the concealment enclosure 13 to the desired height. As mentioned previously, remote control operation of valves 76, 121 can be provided. If remote operability is provided, the hunter can enter the concealment enclosure while hunting stand 11 is in the fully collapsed position (see FIG. 4), and then raise himself and the concealment enclosure to the fully extended position (or a plurality of intermediate positions). If remote operability is not provided, the hunter must manually operate valves 76, 121 to raise concealment enclosure 13 to the desired height. Then, the hunter can climb into the concealment enclosure 13 by using lateral cross members 117 as steps. Although concealment enclosure 13 can be occupied by a hunter and used in one of the intermediate positions, it is preferred that each collapsible frame be in the extended position to minimize the amount of force required from lifting cylinders 35, 37 to support the collapsible frame.

Operation of valves 76, 121, whether by remote or manually, allows pressurized fluid (either compressed air or hydraulic fluid) to be supplied to lifting cylinders 35, 37. Each valve provides individual control over a pair of lifting cylinders. For example, valve 76 controls the supply of pressurized fluid to the pair of first lifting cylinders 35, and valve 121 controls the supply of pressurized fluid to the pair of second lifting cylinders 37. Since these pairs of lifting cylinders are operated independently, there is the ability to completely extend one of the collapsible frames, while keeping the other collapsible frame or frames in a collapsed position. However, it is desirable, when raising concealment enclosure 13, to keep the weight of concealment enclosure 13 and lifting apparatus 15 properly distributed with respect to base 12.

Referring again to FIG. 3 in the drawings, a preferred method of raising concealment enclosure 13 is illustrated. A longitudinal axis 165 associated with lower longitudinal cross member 57 bisects the points of attachment for upper collapsible frame 31 and the points of attachment for lower collapsible frame 33. An angle α1 is formed between longitudinal axis 165 and struts of the upper collapsible frame 31. An angle α2 is formed between longitudinal axis 165 and struts of the lower collapsible frame 33. While raising concealment enclosure 13 with lifting apparatus 15, it is preferable to insure that angle α1 is substantially equal to angle α2. By raising each collapsible frame 31, 33 in coordination with the other, it is possible to keep the weight of concealment enclosure 13 and its occupants distributed over the portion of base 12 where lower collapsible frame 33 attaches, thereby allowing easier lifting of concealment enclosure 13 and a more stable weight distribution with respect to trailer 131 or automobile carrier 145.

As lifting apparatus 15 is used to raise concealment enclosure 13, the concealment enclosure 13 remains substantially level in relation to base 12. This result is due to the equal lengths of the struts of each collapsible frame 31, 33 and the equal distances between the attachment points at the ends of each strut. By insuring that the length of each strut is equal to the length of other struts within that particular collapsible frame 31, 33, and by insuring that the distance between attachment points at one end of a pair of struts is equal to the distance between attachment points at the other end of that pair of struts, the rotational orientation of the concealment enclosure with respect to base 12 will remain relatively constant throughout the raising and lowering process (i.e. the concealment enclosure will remain level).

Even though many of the examples discussed herein are applications of the present invention in the sport of hunting, the present invention also can be used in association with other sports and activities. One skilled in the art will see that the present invention can be applied in many areas where there is a need to provide an elevated platform for observation or accomplishing a task. The present invention could elevate a photographer desiring to have a concealed and elevated view of terrain and wildlife. A forest ranger could use the present invention as a mobile elevation platform for checking for the presence of forest fires. The invention could also be used by military personnel needing a compact and mobile platform for obtaining intelligence on terrain or enemy positions. The invention could also be used as mobile scaffolding in order to provide a work surface for a worker such as a painter, carpenter, welder, or window washer.

A primary advantage of the present invention is that the invention provides a collapsible and mobile lifting apparatus for raising a platform supporting persons and equipment to a desired height. Another advantage of the present invention is that the hunting stand can be easily transported by either towing the stand behind a vehicle or by mounting the stand on the roof of a vehicle. Another advantage of the present invention is that the lifting apparatus is pneumatically or hydraulically powered. Because lifting cylinders are used to extend and collapse the collapsible frames, complex lifting mechanisms such as those requiring pulleys or gears are avoided. Another advantage of the present invention is the modular feature of the lifting apparatus. The lifting apparatus can be configured with more or fewer collapsible frames, depending on the desired height of the concealment enclosure. Another advantage of the present invention is the ability of the lifting apparatus to keep the concealment enclosure level as the concealment enclosure is raised and lowered.

It should be apparent from the foregoing that an invention having significant advantages has been provided. While the invention is shown in only one of its forms, it is not just limited but is susceptible to various changes and modifications without departing from the spirit thereof.

I claim:

1. A lifting apparatus comprising:
a first collapsible frame having a plurality of struts, each of the struts having a first end pivotally attached to one of a plurality of lower longitudinal cross members and a second end pivotally attached to one of a plurality of upper longitudinal cross members;
a second collapsible frame having a plurality of struts, each of the struts having a first end pivotally attached to a base and a second end pivotally attached to one of the lower longitudinal cross members;
a first lifting cylinder pivotally attached at one end to at least one of the lower longitudinal cross members and pivotally attached at another end to at least one of the struts of the first collapsible frame; and
a second lifting cylinder pivotally attached at one end to the base and pivotally attached at another end to at least one of the struts of the second collapsible frame.

2. The lifting apparatus according to claim 1 wherein:
the first lifting cylinder is pneumatically driven to move the first collapsible frame from a collapsed position to an extended position; and
the second lifting cylinder is pneumatically driven to move the second collapsible frame from a collapsed position to an extended position.

3. The lifting apparatus according to claim 1 wherein:
the length of each strut in the first collapsible frame is equal; and
the length of each strut in the second collapsible frame is equal.

4. The lifting apparatus according to claim 1 wherein:
the distance between two selected struts of the second collapsible frame at one of the lower longitudinal cross members is equal to the distance between the two selected struts of the second collapsible frame at the base; and
the distance between two selected struts of the first collapsible frame at one of the lower longitudinal cross members is equal to the distance between the two selected struts of the first collapsible frame at one of the upper longitudinal cross members.

5. The lifting apparatus according to claim 1 further comprising a concealment enclosure rigidly attached to at least one of the upper longitudinal cross members.

6. The lifting apparatus according to claim 1, wherein the first and second collapsible frames are configured such that each frame can be independently collapsed and extended.

7. The lifting apparatus according to claim 1, wherein the first collapsible frame and the second collapsible frame are configured to receive additional collapsible frames for increasing the lifting capability of the lifting apparatus.

8. A hunting stand comprising:
a lower collapsible frame having at least one lifting strut having a first end and a second end and at least one support strut having a first end and a second end, the first ends of the lifting strut and the support strut being pivotally attached to a base;
a lower longitudinal cross member pivotally attached to the second ends of the lifting strut and the support strut of the lower collapsible frame;
an upper collapsible frame having at least one lifting strut having a first end and a second end and at least one support strut having a first end and a second end, the first ends of the lifting strut and the support strut of the upper collapsible frame being pivotally attached to the lower longitudinal cross member;
an upper longitudinal cross member pivotally attached to the second ends of the lifting strut and the support strut of the upper collapsible frame;
a first lifting cylinder pivotally attached at one end to the lower longitudinal cross member and pivotally attached at a second end to the lifting strut of the upper collapsible frame for rotating the upper collapsible frame between a collapsed position and an extended position; and
a second lifting cylinder pivotally attached at one end to the base and pivotally attached at another end to the lifting strut of the lower collapsible frame for rotating the lower collapsible frame between a collapsed position and an extended position.

9. The hunting stand according to claim 8 further comprising a concealment enclosure rigidly attached to the upper longitudinal cross member.

10. The hunting stand according to claim 8 further comprising a concealment enclosure pivotally attached to the second ends of the lifting strut and the support strut of the upper collapsible frame.

11. The hunting stand according to claim 8 wherein the first and second lifting cylinders are pneumatically driven.

12. The hunting stand according to claim 8 wherein:
the upper collapsible frame includes at least a pair of the lifting struts and at least a pair of the support struts;
the lower collapsible frame includes at least a pair of the lifting struts and at least a pair of the support struts;
the pair of lifting struts for both the upper and lower collapsible frames includes at least one lateral cross member rigidly attached between the lifting struts; and
the pair of support struts for both the upper and lower collapsible frames includes at least one lateral cross member rigidly attached between the support struts.

13. The hunting stand according to claim 8 wherein the upper and lower collapsible frames are configured such that each frame can be independently collapsed and extended.

14. The hunting stand according to claim 8, wherein:
the upper collapsible frame is rotated in a first direction to extend the upper collapsible frame from the collapsed position to the extended position;
the lower collapsible frame is rotated in a second direction to extend the lower collapsible frame from the collapsed position to the extended position; and
the first direction is opposite the second direction.

15. The hunting stand according to claim 8 wherein:
the length of each lifting strut and each support strut in the lower collapsible frame is equal;
the length of each lifting strut and each support strut in the upper collapsible frame is equal;
the distance between the support strut and the lifting strut of the lower collapsible frame at the base is equal to the distance between the support strut and the lifting strut of the lower collapsible frame at the lower longitudinal cross member; and
the distance between the support strut and the lifting strut of the upper collapsible frame at the lower longitudinal cross member is equal to the distance between the support strut and the lifting strut of the upper collapsible frame at the upper longitudinal cross member.

16. The hunting stand according to claim 8, wherein:
a longitudinal axis is defined along the lower longitudinal cross member; and
a first angle formed between the longitudinal axis and the lifting and support struts of the upper collapsible frame is substantially equal to a second angle formed between the longitudinal axis and the lifting and support struts of the lower collapsible frame as the hunting stand is moved between the fully collapsed position and the fully extended position.

17. The hunting stand according to claim 8, wherein the base of the hunting stand is carried by a trailer and is configured to be transported from one location to another by towing the trailer behind a vehicle.

18. The hunting stand according to claim 8, wherein the hunting stand is carried by an automobile carrier which is rigidly attached to a roof of a vehicle.

19. The hunting stand according to claim 8, wherein the upper collapsible frame and the lower collapsible frame are configured to receive additional collapsible frames for increasing the lifting height of the hunting stand.

20. A method for raising a concealment enclosure comprising the steps of:
supporting the concealment enclosure with a first collapsible frame having a plurality of struts, each of the struts having a first end pivotally attached to one of a plurality of lower longitudinal cross members and a second end pivotally attached to one of a plurality of upper longitudinal cross members;
supporting the first collapsible frame with a second collapsible frame having a plurality of struts, each of the struts having a first end pivotally attached to a base and a second end pivotally attached to one of the lower longitudinal cross members;
rotating the first collapsible frame from a collapsed position to an extended position;
rotating the second collapsible frame from a collapsed position to an extended position; and
whereby the concealment enclosure is raised by the respective rotations of the first and second collapsible frames.

21. The method according to claim 20, wherein the direction of rotation for extending the first collapsible frame is opposite the direction of rotation for extending the second collapsible frame.

22. The method according to claim 20, wherein:
a longitudinal axis is defined along one of the lower longitudinal cross members;
a first angle is defined between the longitudinal axis and the struts of the first collapsible frame;
a second angle is defined between the longitudinal axis and the struts of the second collapsible frame; and wherein the method further comprises the step of:
positioning the first and second collapsible frames during the rotation of the first and second collapsible frames such that the first angle is substantially equal to the second angle.
